(19) United States
(12) Patent Application Publication
(10) Pub. No.: US 2022/0113962 A1
(43) Pub. Date: Apr. 14, 2022

(54) A METHOD AND A SYSTEM FOR MANAGING COMPATIBILITY BETWEEN TWO PIECES OF EQUIPMENT

(71) Applicant: SAFRAN ELECTRONICS & DEFENSE, Paris (FR)

(72) Inventors: Denis DELVILLE, MOISSY-CRAMAYEL (FR); Sangeerthman SUBRAMANIAM, MOISSY-CRAMAYEL (FR); Michel BALANDRAS, MOISSY-CRAMAYEL (FR); Louis-Théophile THIRION, MOISSY-CRAMAYEL (FR)

(21) Appl. No.: 17/497,563

(22) Filed: Oct. 8, 2021

(30) Foreign Application Priority Data
Oct. 9, 2020 (FR) 2010363

(51) Int. Cl. G06F 8/71; G06F 8/65

(52) U.S. Cl. CPC G06F 8/71; G06F 8/65

(57) ABSTRACT

A management method for managing compatibility between a first piece of equipment and a second piece of equipment connected together by communication interfaces. The method comprises the following steps: the first piece of equipment sending first compatibility information to the second piece of equipment, which first compatibility information is representative of the first data formats; the second piece of equipment preparing second compatibility information identifying at least one of the first formats that corresponds to the second format; and the second piece of equipment determining a level of compatibility with the first piece of equipment from the second compatibility information.

A system for implementing the method.

The present invention relates to the field of computing, and more particularly to managing compatibility between two pieces of equipment such as pieces of equipment on board an aircraft, or any other transport means (by rail, by road, . . . ), and including a plurality of computers. The invention relates in particular to operations of updating software installed in the on-board computers (which operations are also referred to as “data loading”).

### BACKGROUND OF THE INVENTION

In order to optimize the reliability of aircraft and to increase their profitability, maintenance operations are performed frequently. Such maintenance operations include in particular modifying the hardware and software configuration of the computers of the aircraft.

Just like installing a new computer, updating the software configuration of the computers requires intervention by a software operator on board the aircraft. The operator must follow predefined procedures so as to avoid any hardware or software error that could run the risk of putting the aircraft into a mode of operation that is poor or faulty, and that might have consequences that are potentially dangerous.

Conventionally, such procedures rely on a list of identifiers of computers and/or of software configurations that are compatible with the new computer and/or the new software configuration. The list is drawn up when requesting certification of said new computer and/or of said new software configuration. Thus, prior to any new installation or to any software updating, the maintenance operator or the configuration manager verifies that the list does indeed contain the identifiers of the computers and/or of the software configurations with which the new computer or the new software configuration is to exchange data.

Under such circumstances, verification of software compatibility between the pieces of equipment on board the aircraft is performed manually. Any human error can thus be corrected only by operational constraints that are burdensome (signing maintenance operation reports, double checking, . . . ).

### OBJECT OF THE INVENTION

An object of the invention is thus to propose a method of managing software compatibilities between two pieces of equipment in a manner that is automatic, reliable, and effective.

15

### SUMMARY OF THE INVENTION

For this purpose, there is provided a method of managing compatibility between a first piece of equipment and a second piece of equipment. The first piece of equipment has a communication interface connected to a communication interface of the second piece of equipment, the first piece of equipment being compatible with first data formats and the second piece of equipment being compatible with at least one second data format. According to the invention, the method comprises the following steps:

the first piece of equipment sending first compatibility information to the second piece of equipment, which first compatibility information is representative of the first data formats;

the second piece of equipment preparing second compatibility information identifying at least one of the first formats that corresponds to the second format; and

the second piece of equipment determining a level of compatibility with the first piece of equipment from the second compatibility information.

Thus, the first piece of equipment sends compatibility information to the second piece of equipment enabling the second piece of equipment to identify whether it is compatible with the first piece of equipment in a manner that is safe and automatic.

According to a particular characteristic of the invention, the method includes the second piece of equipment issuing a warning signal characteristic of the level of compatibility determined by said second piece of equipment.

According to another particular characteristic of the invention, the method further comprises the following steps:

the second piece of equipment sending the second compatibility information to the first piece of equipment; and

the first piece of equipment sending data in one of the first formats identified by the second compatibility information.

Thus, the first and second pieces of equipment exchange compatibility information, thereby enabling the first piece of equipment to be sure of sending the data in a format that is compatible with the second piece of equipment, and also enabling it to identify whether it is compatible with the second piece of equipment in a manner that is safe and automatic. The method of the invention thus makes it possible to transfer data reliably, thereby serving to limit any risk of the data received by the second piece of equipment being interpreted wrongly. The first piece of equipment may be a piece of equipment that is to be connected temporarily to the second piece of equipment, e.g. for maintenance purposes, or it may be a piece of equipment that is to be connected permanently to the second piece of equipment.

In a preferred implementation of the invention, the compatibility information comprises identifiers of interface control documents of the first piece of equipment.

By way of example, these documents may be standards documents defining a communication protocol and drawn up by a standards body, by a manufacturer of electronic equipment, or by a group of manufacturers.

These documents could equally well be technical specifications for computer interfaces (also known as “interface control documents” (ICDs)) drawn up by an equipment manufacturer or by a systems integrator.

In particular manner, each identifier comprises a reference accompanied by a version index and by a revision index.

In particular manner, each identifier further comprises an additional parameter representative of at least one communication channel of the interface of the first piece of equipment.

In particular manner, each identifier also includes a chapter indicator.

In particular manner, the first and second pieces of equipment are computers on board an aircraft.

The invention also provides a set of pieces of electronic equipment arranged to perform such a method.

### BRIEF DESCRIPTION OF THE DRAWINGS

The invention can be better understood in the light of the following description, which description is purely illustrative and nonlimiting, and should be read with reference to the sole accompanying figure, in which:

The sole figure is a diagrammatic view of the steps of a method of managing software compatibilities in a particular implementation of the invention.

### DETAILED DESCRIPTION OF THE INVENTION

The invention is described herein in its application to first and second computers C1 and C2 on board aircraft. The computers are pieces of electronic equipment that are themselves known, and each of them comprises at least one processor and memory enabling it to execute computer programs and to process data. The first computer C1 has a communication interface I1 connected to a communication interface I2 of the second computer C2.

The computer C1 is compatible with first data formats F1, and the interface I1 of said computer C1 supports first protocols P1.

The data formats F1 and the protocols P1 are described in first documents ICD1 referred to as “interface control documents”.

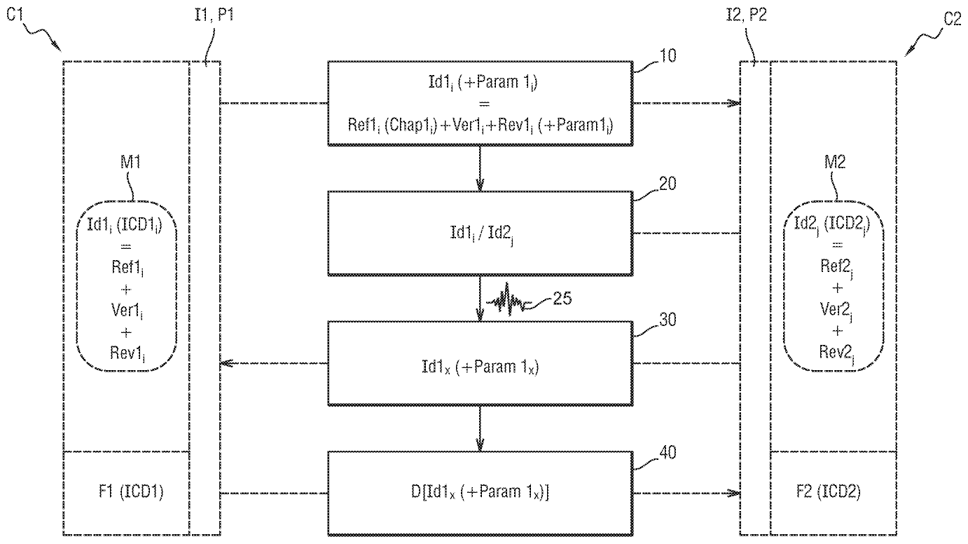

Each document ICD1 is defined by a unique identifier Id1 that comprises a reference Ref1 accompanied by a version index Ver1 and by a revision index Rev1 corresponding to a given state of change in the content of the document ICD1. In FIG. 1, the identifiers Id1 and their components (reference Ref1, version index Ver1, revision index Rev1) are distinguished by adding the letter “i”.

An increment of the revision index Rev1 represents a minor change to the content of the document ICD1 in question, such that the first data format(s) F1 defined by the document ICD1 for which the revision index Rev1 has been incremented remain compatible with the data format(s) defined by the preceding revision index Rev1. When the revision index Rev1 is incremented, the version index Ver1 remains unchanged.

An increment of the version index Ver1 represents a major change to the content of the document ICD1, such that the first data format(s) F1 defined by the document ICD1 for which the version index Ver1 has been incremented are incompatible with the data format(s) defined by the preceding version index Ver1. When the version index Ver1 is incremented, the revision index Rev1 is reinitialized.

The identifiers Id1 of the documents ICD1 are stored in a memory M1 of the computer C1, and they form first compatibility information representative of the first data formats F1 with which said computer C1 is compatible.

The computer C2 is compatible with second data formats F2, and the interface I2 of said computer C2 supports second protocols P2.

The data formats F2 and the protocols P2 are described in second interface control documents ICD2.

As for the documents ICD1, each document ICD2 is defined by a unique identifier Id2 that comprises a reference Ref2 accompanied by a version index Ver2 and by a revision index Rev2 corresponding to a given state of change in the content of the document ICD2. In FIG. 1, the identifiers Id2 and their components (reference Ref2, version index Ver2, revision index Rev2) are distinguished by adding the letter “j”.

An increment of the revision index Rev2 represents a minor change to the content of the document ICD2 in question, such that the second data format(s) F2 defined by the document ICD2 for which the revision index Rev2 has been incremented remain compatible with the data format(s) defined by the preceding revision index Rev2. When the revision index Rev2 is incremented, the version index Ver2 remains unchanged.

An increment of the version index Ver2 represents a major change to the content of the document ICD2 in question, such that the second data format(s) F2 defined by the document ICD2 for which the version index Ver2 has been incremented are incompatible with the data format(s) defined by the preceding version index Ver2. When the version index Ver2 is incremented, the revision index Rev2 is reinitialized.

The identifiers Id2 of the documents ICD2 are stored in a memory M2 of the computer C2, and they form second compatibility information representative of the second data formats F2 with which said computer C2 is compatible.

In a particular implementation of the invention as shown in FIG. 1, the first and second computers C1 and C2 perform a sequence of operations to ensure that the operating data D of the aircraft as transmitted by the first computer C1 to the second computer is in a format that is compatible with said second computer C2.

During a first step 10 of initializing communication, the first computer C1 sends, to the second computer C2, all of the first identifiers Id1 of the interface control documents for the interface I1.

Thereafter, the second computer C2 compares the first identifiers Id1 sent by the first computer C1 with the second identifiers Id2 of the interface control documents for the interface I2, and it prepares a list of said first identifiers Id1 that are identical to the second identifiers Id2 or that are compatible with said second identifiers Id2 (step 20), i.e.:

one of the first identifiers Id1 and one of the second identifiers Id2 refer to the same revision of the same version of the same document;

one of the first identifiers Id1 and one of the second identifiers Id2 refer to two different but compatible revisions of the same version of the same document;

one of the first identifiers Id1 and one of the second identifiers Id2 refer to two different but compatible versions of the same document; or

one of the first identifiers Id1 and one of the second identifiers Id2 refer to two documents that are different, but that are mutually compatible.

If the list prepared by the second computer C2 is empty or does not guarantee a sufficient level of compatibility, then said second computer C2 issues a warning signal (step 25) informing the maintenance operator or an organization for managing proper operation that the system constituted by the first and second computers C1 and C2 is not operational. By way of example, the level of compatibility is determined on the basis of the number of identifiers Id1 that are included in the list or on the basis of the presence in said list of one or more predetermined identifiers Id1.

If the list prepared by the second computer C2 is not empty and guarantees a sufficient level of compatibility, then said second computer C2 sends said list to the first computer C1 (step 30) and issues a warning signal (step 25) informing the maintenance operator or the organization for managing proper operation that the system constituted by the first and second computers C1 and C2 is operational. In FIG. 1, the identifiers Id1 making up the list are distinguished by adding the letter “x”.

Thereafter, the first computer C1 selects one of the first identifiers Id1 returned by the second computer C2, e.g. the identifier that it considers to be the most appropriate, and it transmits the operating data D of the aircraft in the data format F1 described in the document ICD1 corresponding to the selected first identifier Id1 (step 40).

The first and second computers C1 and C2 have thus mutually exchanged compatibility information enabling said first computer C1 to send the data D in a format that is compatible with said second computer C2. This information may also be used by the second computer C2 for sending other operating data in return to the first computer C1, and for doing so in a format that is compatible with said first computer C1.

Such a method also enables the first and second computers C1 and C2 detect mutual incompatibilities automatically and in autonomous manner, and thus to add automatic verification of compatibility in compliance with the quality constraints for developing critical computers.

What's more, implementing such a management method is found to be simple, capable of being generalized to any electronic equipment, and scalable. Furthermore, with such a compatibility management method, it is possible to make computers that are capable of adapting their data acquisition or decoding functions in compliance with the compatibility information they have exchanged.

By way of example, the first and second identifiers

Id1, Id2 may be identifiers of the standards implemented by the computer buses used for conveying data between the two computers C1 and C2, such as the standards “ARINC 615-3”, “ARINC 664 part 7”, “ARINC 739A”, . . . . As shown in FIG. 1, provision may be made for the first computer C1 to send an additional parameter in addition to the first identifiers Id1 of the control documents ICD1 for the interface I1, which additional parameter is referenced “Param1” herein and is representative of a communication channel of said interface I1. This additional parameter Param1 may serve in particular to manage compatibilities on each of the communication channels of the interfaces I1 and 12. Such compatibility management is appropriate in particular for aircraft architectures based on the standard “ARINC 664 part7”.

In order to make compatibility management between the computers C1 and C2 even more accurate, provision may also be made for the first computer C1 to send a chapter indicator in addition to the reference Ref1, the version index Ver1, and the revision index Rev1, which indicator is referenced Chap1 and is representative of a chapter of the first documents ICD1. This indicator serves to manage compatibilities on each frame of each of the communication channels of the interfaces I1 and 12. Such compatibility management is appropriate in particular for aircraft architectures based on the standard “ARINC 664 part7”.

It is also possible to add an additional field to be identifiers in order:

to indicate that a computer is a prototype for use in laboratory testing and that therefore should not be installed in an aircraft; and/or

to indicate the presence of a bug such as one or more data items not complying with their specifications or with their transmission constraints.

Naturally, the invention is not limited to the implementations described but covers any variant coming within the ambit of the invention as defined by the claims.

Although, above, use is made of interface control document identifiers, other types of identifier can be used, providing they enable the specifications of the interfaces between the computers to which they relate to be identified uniquely.

Although, above, the method is applied to two computers of an aircraft, it can be applied to any pieces of equipment that exchange data.

1. A management method for managing compatibility between a first piece of equipment and a second piece of equipment, the first piece of equipment having a communication interface connected to a communication interface of the second piece of equipment, and the first piece of equipment being compatible with first data formats and the second piece of equipment being compatible with at least one second data format, the method comprising the following steps:
the first piece of equipment sending first compatibility information to the second piece of equipment, which first compatibility information is representative of the first data formats;
the second piece of equipment preparing second compatibility information identifying at least one of the first formats that is compatible with the second format; and
the second piece of equipment determining a level of compatibility with the first piece of equipment from the second compatibility information, the compatibility information comprising identifiers of interface control documents of the first piece of equipment, and
the method being characterized in that each identifier comprises a reference accompanied by a version index and by a revision index.

2. The management method according to claim 1, including the second piece of equipment issuing a warning signal characteristic of the level of compatibility determined by said second piece of equipment.

3. The management method according to claim 1, comprising the steps of:
the second piece of equipment sending the second compatibility information to the first piece of equipment; and
the first piece of equipment sending data in one of the first formats identified by the second compatibility information.

4. The management method according to claim 1, wherein the interface control documents comprise standards defining a communication protocol.

5. The management method according to claim 1, wherein the compatibility information includes an additional parameter representative of a communication channel of the interface of the first piece of equipment.

6. The management method a according to claim 1, wherein each identifier also includes a chapter indicator.

7. The management method according to claim 1, wherein the first and second pieces of equipment are computers on board an aircraft.

8. A set of pieces of electronic equipment arranged to perform the management method according to claim 1.
